(19) United States
(12) Patent Application Publication
(10) Pub. No.: US 2015/0356676 A1
(43) Pub. Date: Dec. 10, 2015

(54) EQUITY INDEX BASED ON STABILITY OF ROE

(71) Applicant: Fuller & Thaler Asset Management, Inc., San Mateo, CA (US)

(72) Inventors: Russell Jay Fuller, Hillsborough, CA (US); Yining Tung, Hillsborough, CA (US)

(21) Appl. No.: 14/300,207

(22) Filed: Jun. 9, 2014

(51) Int. Cl. G06Q 40/04

(52) U.S. Cl. CPC G06Q 40/04

(57) ABSTRACT

Systems and methods to provide a stock index are based on return-on-equity (ROE). The variance of ROE is obtained and/or determined per stock. Low variance is considered an indicator of stability. The weights for the stocks in the stock index are chosen and/or adjusted to minimize the variance of the ROE of the stock index.

### FIELD

The disclosure relates to systems and methods for providing a stock index and rebalancing a stock index, and, in particular, using financial parameters based on return-on-equity (ROE) to determine a stability-based index.

### BACKGROUND

Investment strategies may be based on active indexing, passive indexing, and/or some combination of both. In many cases, a passive equity index is created through one-time, up-front, active decisions to select and weight certain stocks, and determine when and how to rebalance the index going forward. The stocks that are considered eligible for inclusion in an index are jointly referred to as the “universe of stocks.” Common equity indexes include the S&P 500, the Russell 1000® Index, and the Russell 3000E™ Index.

Equity index strategies are usually based on financial parameters related to stocks and/or the business entities corresponding to those stocks. Financial parameters may include, but are not limited to, return data and fundamental data.

The performance of an equity index strategy may be characterized through multiple parameters, including but not limited to statistical parameters, such as rate of (excess) return, Sharpe ratio, information ratio, Fama/French/Carhart alpha, volatility, risk, and/or other parameters.

### SUMMARY

One aspect of the disclosure relates to systems and methods to provide a stock index including stocks and weights associated with the stocks. In some aspects, a stock index may be a mathematical construct that is determined based on prices and/or weights of selected and/or participating stocks. Financial and/or investment services may be based on a stock index. For example, a (mutual) fund and/or portfolio may track a stock index. As used herein, the terms “stock index” and “equity index” may be used interchangeably.

The systems described herein may be implemented in a computer system that includes, by way of non-limiting example, one or more physical processors, one or more servers, physical electronic storage, one or more computer program components, and/or other components. The system may be configured to interact with one or more providers of data and/or information, including but not limited to providers of financial and/or historical information related to stocks and/or business entities (also referred to as financial information provider), providers of information specific to a business entity and/or stock (also referred to as business information provider), and/or other providers.

As used herein, a business entity that corresponds to, is associated with, and/or is otherwise affiliated with stocks, equity, and/or other (publicly) tradable financial instruments may be referred to as “having stock” and/or “including stock.” Reciprocally, such stock may be referred to as being “of a business entity” or “belonging to a business entity.” For example, the “stock of a business entity” or a “business entity's stock” may be interpreted as the stocks, equity, and/or other (publicly) tradable financial instruments that correspond to, are associated with, and/or are otherwise affiliated with a particular business entity. As used herein, a business entity may be referred to generically as a company, without regard for corporate structure or organization.

Users may interact with the system through client computing platforms. Client computing platforms may include one or more processors configured to execute computer program components. The computer program components may be configured to enable a user associated with a client computing platform to interact with the system, any component thereof, other client computing platforms, and/or provide other functionality attributed herein to client computing platforms. By way of non-limiting example, client computing platforms may include one or more of a desktop computer, a laptop computer, a handheld computer, a NetBook, a Smartphone, a tablet, a mobile computing platform, a gaming console, a television, a device for streaming internet media, and/or other computing platforms.

The one or more servers included in the system may include one or more processors configured to execute computer program components. The system may include physical storage, which may be physically located in one location, or may be distributed in different locations, including but not limited to “the cloud”.

The computer program components may include one or more of a historical component, a statistical component, an index component, an eligibility component, a matrix component, a rebalance component, a portfolio component, and/or other components.

The historical component may be configured to determine and/or obtain financial parameters for business entities. As used herein, the term “obtain” and (derivatives thereof) includes active and/or passive determination, transfer, and/or exchange of information, and/or any combination thereof. Obtaining financial parameters and/or other financial information may include determination (e.g. within the system), retrieval from a database, one or more financial information providers, and/or other providers of information. The business entities may include business entities that correspond to, are associated with, and/or otherwise affiliated with stocks, equity, and/or other (publicly) tradable financial instruments. The business entities for which financial parameters are determined and/or obtained may be referred to as a set of business entities. The corresponding stocks may be referred to as a set of stocks. Assume that the set of business entities includes company A, company B, company C, and so forth. Assume that the corresponding stock may be referred to as A, B, C, etc.

Financial parameters for a given business entity may include one or more of historical stock price information, historical financial performance information, any information that publicly traded business entities are required to report, and/or other financial information specific to the given business entity. For example, financial performance information may include return-on-equity (ROE), and/or other financial performance information. For example, the ROE for companies A, B, and C may be referred to as ROE_{A}, ROE_{B}, and ROE_{C}, respectively. In some implementations, the historical component may be configured to obtain sets of financial parameters that are specific to an individual business entity. For example, for companies A, B, and C, the sets of financial parameters may be a set of values for ROE_{A}, ROE_{B}, and ROE_{C}, respectively. As used herein, the ROE of a particular business entity that corresponds to a particular stock may be referred to as the ROE of that particular stock.

In some implementations, financial parameters for a given business entity may be derived from one or more of historical stock price information, historical financial performance information, any information that publicly traded business entities are required to report, and/or other financial information specific to the given business entity. In some implementations, a particular financial performance parameter may be derived from and/or otherwise based on the ROE for a particular business entity. Particular individual business entities and/or their stocks may be excluded, discarded, eliminated, disqualified, and/or otherwise removed from the set of business entities such that the particular business entities and/or their stocks are no longer eligible for consideration for a stock index. For example, in some implementations, if certain financial parameters are not available, a particular stock may not be used for a stock index. The process of determining a stock index may include using a set of eligibility criteria, including but not limited to certain financial parameters being available, to reduce the set of business entities to a subset of business entities and/or reduce the set of stocks to a subset of stocks. Reduction may include multiple steps, e.g. by applying multiple eligibility criteria, e.g. sequentially.

The statistical component may be configured to determine and/or obtain statistical parameters associated with one or more financial parameters. In some implementations, a statistical parameter may be the average for a set of financial parameters, e.g. the average, mean, or median of a set of values for ROE. In some implementations, a statistical parameter may indicate probability distributions for a set of financial parameters. By way of non-limiting example, a statistical parameter may include and/or be based on the variance of a set of values of a particular financial performance parameter, e.g. a set of values for ROE. A statistical parameter, e.g. variance, may be specific to a stock and/or business entity. For example, the variance of the stock of company A may be referred to as V_{A}, the variance of the stock of company B may be referred to as V_{B}, and so forth. For example, the variance of the ROE for company A may be referred to as V_{ROE-A}, the variance of the ROE for company B may be referred to as V_{ROE-B}, and so forth.

In some implementations, for individual business entities, a set of values of a particular financial performance parameter may form a sequence of values that are associated with different dates in a range of dates. For example, a sequence of values may be associated with quarterly reported financial information (e.g. a quarterly finance report) for the quarters that span a particular range of dates. Per year, these quarters may be referred to as Q1, Q2, Q3, and Q4. For example, for business-specific financial performance information that is reported per quarter, a sequence of eight values, e.g. reported income, assets, and/or liabilities, may span the eight quarters that span two years, e.g. 2013-2014, or, more specifically, Q1-2013, Q2-2013, Q3-2013, Q4-2013, Q1-2014, Q2-2014, Q3-2014, and Q4-2014. The values for a particular financial performance parameter corresponding to such a set or sequence may be used, by the statistical component, to determine, approximate, and/or otherwise derive one or more statistical parameters. For example, the statistical component may be configured to determine, by way of non-limiting example, the average, mean, median, and/or variance of ROE for a sequence of (quarterly reported) ROE-values for a particular business entity and/or the stock thereof. As used herein, the term “determine” (and derivatives thereof) may include measure, calculate, compute, estimate, approximate, and/or otherwise derive.

In some implementations, the statistical component may be configured to obtain and/or determine statistical parameters related to financial parameters of two or more business entities and/or stocks thereof. For example, the statistical component may be configured to determine a covariance between two sets of particular financial performance parameters, each set being specific to a different business entity or stock. In some implementations, to determine a covariance, the two sets may need to span the same range of dates. For example, assuming that the variance of the ROE for company A (V_{ROE-A}) spans the same range of dates as the variance of the ROE for company B (V_{RoE-B}), the statistical component may be configured to determine a covariance between the ROE of company A and company B, which may be referred to as CV_{ROE-AB,} or CV_{AB} for short. Likewise, the covariance between the ROE (or another financial parameter) of company X and company Y may be referred to as CV_{XY}.

The eligibility component may be configured to select and/or discard individual business entities from the set of business entities based on one or more eligibility criteria. The eligibility component may be configured to select and/or discard individual stocks from the set of stocks based on one or more eligibility criteria. In some implementations, selecting and/or discarding a business entity or stock may imply selecting and/or discarding the corresponding stock or business entity, and vice versa. One or more of the eligibility criteria may be based on one or more statistical parameters that are specific to individual business entities. One or more of the eligibility criteria may be based on one or more statistical parameters that are not specific to individual business entities, but rather related to the relation and/or interaction between different business entities and/or stocks.

The portfolio component may be configured to determine one or more index parameters. An index parameter may reflect a financial parameter for a set of business entities and/or stocks. For example, an index parameter may reflect ROE for the subset of stocks (and/or their corresponding business entities) selected by the eligibility component. In some implementations, an index parameter may reflect a statistical parameter based on a financial parameter for a set of business entities and/or stocks. For example, an index parameter may reflect the variance of ROE for the subset of stocks (and/or their corresponding business entities) selected by the eligibility component.

The index component may be configured to determine a stock index of a set of stocks. For example, the index component may be configured to determine a stock index of the subset of stocks, e.g. as selected by the eligibility component. Individual stocks included in the stock index may be associated with a particular weight or weight factor that reflect how much the stock index depends on a particular stock.

In some implementations, the index component may be configured to determine individual weights for individual stocks in the subset of stocks that are included in the stock index. In some implementations, individual weights may be determined by minimizing, reducing, maximizing, and/or increasing one or more index parameters. For example, individual weights may be determined by reducing and/or minimizing the variance of an index parameter that reflects ROE for the subset of stocks included in the stock index.

The matrix component may be configured to generate a covariance matrix for the subset of stocks based on statistical parameters, e.g. the statistical parameters obtained by the statistical component. For example, for a covariance matrix of company A, B, and C, the entries in the covariance matrix may be (from left to right, from top to bottom) V_{A}, CV_{AB}, CV_{AC}; CV_{BA}, V_{B}, CV_{BC}; CV_{CA}, CV_{CB}, V_{C}. In some implementations, the covariance matrix may be referred to as a variance-covariance matrix.

The rebalance component may be configured to rebalance the stock index through adjustments of the selected subset of stocks and/or adjustments of corresponding weights. Adjustments of the individual weights may be determined by minimizing the variance of the statistical parameters of the stock index, e.g. in light of new financial parameters for the set of business entities that were not available or used when the stock index was created, determined, or previously rebalanced.

Interaction with the system may be accomplished through web pages, (mobile) applications, apps, stand-alone applications, desktop applications, and/or other types of software applications capable of interacting with a network, for example the internet. As used herein, content provided through any type of software application capable of interacting with a network may be referred to as a web page (including, but not limited to, mobile applications or “apps”).

Web pages may be rendered, interpreted, and/or displayed for presentation using a computing platform, such as a client computing platform. As used herein, displaying information through a mobile application—or app—is included in the term presentation. Presentation of web pages may be supported through a display, screen, monitor of the computing platform, and/or projection by the computing platform. Web pages may be accessible from a local computing platform (e.g. not currently connected to the internet) and/or hosted by a remote web server (e.g. connected to the internet and/or one or more other networks). Web pages may be accessed through a browser software application being executed on a computing platform.

As used herein, mobile applications may be included in the term browser software application. Web pages may be static (e.g. stored using electronic storage that is accessible by a web server), dynamic (e.g. constructed when requested), and/or a combination of both. The browser software application may be configured to render, interpret, and/or display one or more web pages for presentation using a computing platform. The digital content included in a web page may have been provided by one or more content providers. A set of linked and/or organized web pages may form a website. A website may include a set of related and/or linked web pages hosted on one or more web servers and accessible via a network, e.g. the internet. Websites and/or web pages may be accessible through an address called a uniform resource locator (URL).

By virtue of the systems and methods described in this disclosure, users may provide, determine, and/or rebalance one or more stock indices.

As used herein, any association (or correspondency) involving users, stocks, business entities, weights, parameters, eligibility criteria, weight constraints, statistical operations, and/or another objects and/or entities related to any part of the system, may be a one-to-one association, a one-to-many association, a many-to-one association, and/or a many-to-many association or N-to-M association (note that N and M may be different numbers greater than 1). For example, if object “X” corresponds to object “Y”, this relation may be one-to-one, one-to-many, many-to-one, and/or many-to-many. These and other objects, features, and characteristics of the servers, systems and/or methods disclosed herein, as well as the methods of operation and functions of the related elements of structure and the combination of parts and economies of manufacture, will become more apparent upon consideration of the following description and the appended claims with reference to the accompanying figures, all of which form a part of this specification, wherein like reference numerals designate corresponding parts in the various figures. It is to be expressly understood, however, that the figures are for the purpose of illustration and description only and are not intended as a definition of any limits. As used in the specification and in the claims, the singular form of “a”, “an”, and “the” include plural referents unless the context clearly dictates otherwise. As used in the specification and in the claims, in a list of items that includes the separator “and/or”, combinations of those items, insofar as practically possible, are envisioned as embodiments.

### BRIEF DESCRIPTION OF THE DRAWINGS

FIG. 1 schematically illustrates a system configured to provide a stock index in accordance with one or more implementations.

FIG. 2A illustrates a graph that includes financial information for multiple companies.

FIG. 2B illustrates a variance-covariance matrix based on financial information for multiple companies.

FIG. 3 illustrates a method for providing a stock index in accordance with one or more implementations.

### DETAILED DESCRIPTION

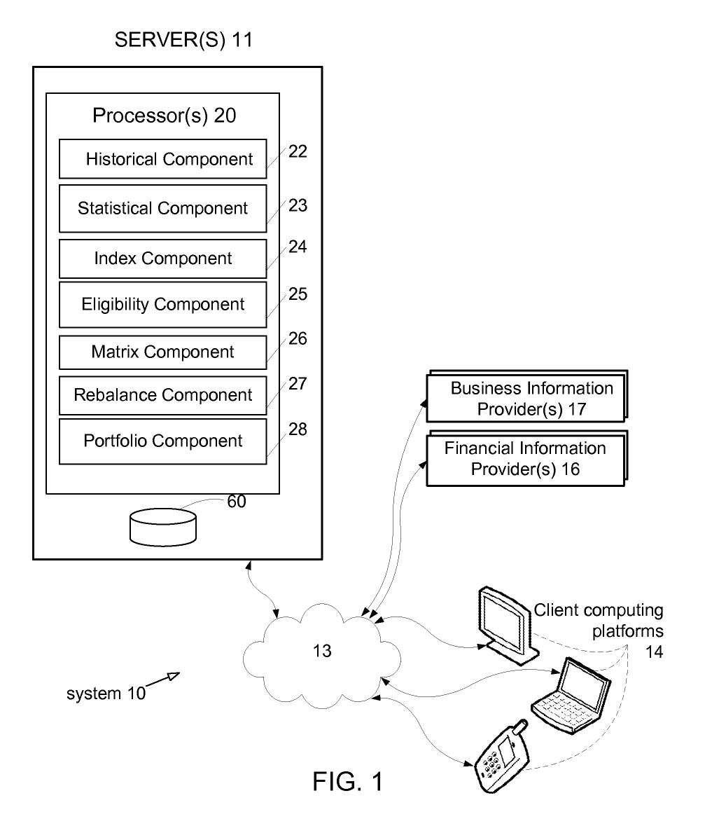

FIG. 1 illustrates a system 10 configured to provide a stock index. System 10 may facilitate communication and/or interaction between users and providers. The providers may include, by way of non-limiting example, one or more financial information providers 16, one or more business information providers 17, and/or other providers, entities, and/or users. Users may interact with system 10 through client computing platforms 14. Interaction may be supported by one or more networks 13, including but not limited to the internet.

Financial information providers 16 may provide and/or manage financial information. Financial information may be related to business entities and/or stocks. In some implementations, financial information may be specific to business entities and/or stocks. For example, financial information may include stock prices, balance sheet information, earnings after taxes, (average) book value, net income, shareholder's equity, net margin, asset turnover, financial leverage, return-on-equity (ROE), and/or other financial information, including but not limited to information derived from and/or based on any of the types of financial information included in this disclosure. Financial information may include historical information, e.g. historical stock prices, and/or other historical financial information. System 10 may be configured to access information that is provided and/or managed by one or more financial information providers 16.

Business information providers 17 may provide and/or manage business information specific to a business entity. For example, business information may include the place of incorporation of individual business entities, valuation information of individual business entities, size and/or financial performance of individual business entities, the number of employees of individual business entities, location of headquarters, location where stocks are traded, location of assets, location of revenues, location of the most liquid exchange (e.g. as defined by two-year average daily dollar trading volume), home country indicators, non-financial parameters and/or information of individual business entities, and/or other business information.

As depicted in FIG. 1, system 10 may include one or more servers 11, one or more processors 20, physical storage 60, and/or other components.

One or more processors 20 (interchangeably referred to herein as processor 20) may be configured to execute computer program components. The computer program components may include a historical component 22, a statistical component 23, an index component 24, an eligibility component 25, a matrix component 26, a rebalance component 27, a portfolio component 28, and/or other components. The functionality provided by components 22-28 may be attributed for illustrative purposes to one or more particular components of system 10, for example a particular provider. This is not intended to be limiting in any way, and any functionality may be provided by any component or entity described herein.

Historical component 22 may be configured to determine and/or obtain financial parameters for business entities. As used herein, the term “obtain” and (derivatives thereof) includes active and/or passive transfer and/or exchange of information, and/or any combination thereof. Obtaining financial parameters and/or other financial information may include retrieval from a database, one or more financial information providers 16, one or more business information providers 17, and/or other providers of information. The business entities may include business entities that correspond to, are associated with, and/or otherwise affiliated with stocks, equity, and/or other (publicly) tradable financial instruments. The business entities for which financial parameters are determined and/or obtained may be referred to as a set of business entities. The corresponding stocks may be referred to as a set of stocks. Assume that the set of business entities includes company A, company B, company C, and so forth. Assume that the corresponding stock may be referred to as A, B, C, etc.

Financial parameters may include historical stock price information, historical financial performance information, any information that publicly traded business entities are required to report, and/or other financial information specific to individual business entities. For example, financial performance information may include return-on-equity (ROE), and/or other financial performance information. For example, the ROE for companies A, B, and C may be referred to as ROE_{A}, ROE_{B}, and ROE_{C}, respectively. In some implementations, historical component 22 may be configured to obtain sets of financial parameters that are specific to an individual business entity. For example, for companies A, B, and C, the sets of financial parameters may be a set of values for ROE_{A}, ROE_{B}, and ROE_{C}, respectively.

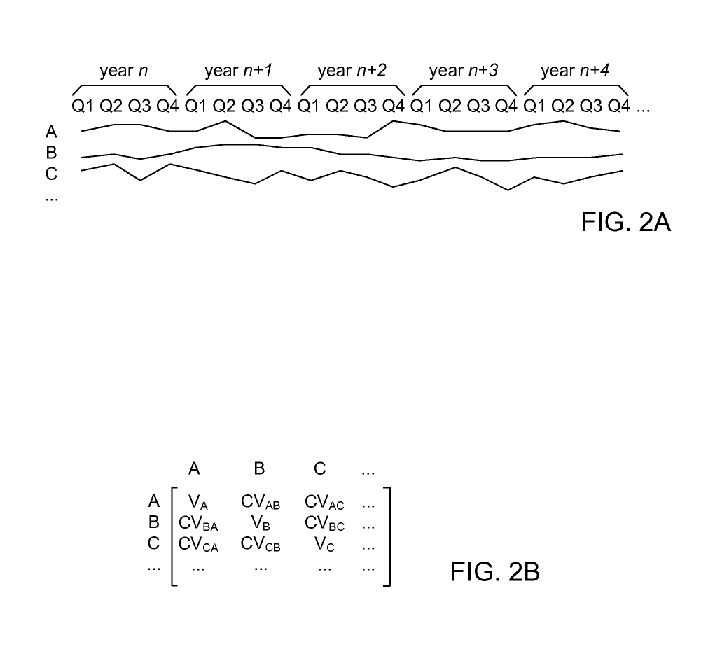

By way of non-limiting example, FIG. 2A illustrates exemplary financial parameters spanning five years of quarterly information for companies A, B, C, and/or other companies. By way of non-limiting example, the financial parameters may comprise, relate to, and/or be derived from return-on-equity (ROE) information.

In some implementations, financial parameters may be derived from historical stock price information, historical financial performance information, any information that publicly traded business entities are required to report, and/or other financial information specific to individual business entities. In some implementations, the ROE for a particular business entity may be derived from the net income and the shareholders' equity. In some implementations, the ROE for a particular business entity may be derived from the net margin, asset turnover, and financial leverage, e.g. according to the Dupont formula. In some implementations, a particular financial performance parameter may be derived from and/or otherwise based on the ROE for a particular business entity. Particular individual business entities and/or their stocks may be excluded, discarded, eliminated, disqualified, and/or otherwise removed from the set of business entities such that the particular business entities and/or their stocks are no longer eligible for consideration for a stock index. For example, in some implementations, if certain financial parameters are not available, a particular stock may not be used for a stock index. The process of determining a stock index may include using a set of eligibility criteria, including but not limited to certain financial parameters being available, to reduce the set of business entities to a subset of business entities and/or reduce the set of stocks to a subset of stocks. Reduction may include multiple steps, e.g. by applying multiple eligibility criteria, e.g. sequentially.

Referring to FIG. 1, statistical component 23 may be configured to determine and/or obtain statistical parameters associated with one or more financial parameters. In some implementations, a statistical parameter may be the average for a set of financial parameters, e.g. the average, mean, and/or median of a set of values for ROE. In some implementations, a statistical parameter may indicate probability distributions for a set of financial parameters. By way of non-limiting example, a statistical parameter may include and/or be based on the variance of a set of values of a particular financial performance parameter, e.g. a set of values for ROE. A statistical parameter, e.g. variance, may be specific to a stock and/or business entity. For example, the variance of the stock of company A may be referred to as V_{A}, the variance of the stock of company B may be referred to as V_{B}, and so forth. For example, the variance of the ROE for company A may be referred to as V_{ROE-A}, the variance of the ROE for company B may be referred to as V_{ROE-B}, and so forth.

In some implementations, for individual business entities, a set of values of a particular financial performance parameter may form a sequence of values that are associated with different dates in a range of dates. For example, a sequence of values may be associated with quarterly reported financial information (e.g. a quarterly finance report) for the quarters that span a particular range of dates. Per year, these quarters may be referred to as Q1, Q2, Q3, and Q4. For example, for business-specific financial performance information that is reported per quarter, a sequence of eight values, e.g. reported income, assets, and/or liabilities, may span the eight quarters that span two years, e.g. 2013-2014, or, more specifically, Q1-2013, Q2-2013, Q3-2013, Q4-2013, Q1-2014, Q2-2014, Q3-2014, and Q4-2014. The values for a particular financial performance parameter corresponding to such a set or sequence may be used, by statistical component 23, to determine, approximate, and/or otherwise derive one or more statistical parameters. For example, statistical component 23 may be configured to determine, by way of non-limiting example, the average, mean, and/or variance of ROE for a sequence of (quarterly reported) ROE-values for a particular business entity and/or the stock thereof.

By way of non-limiting example, FIG. 2A illustrates exemplary financial parameters spanning five years (e.g. year n, n+1, n+2, n+3, and n+4) of quarterly information for companies A, B, C, and/or other companies. Statistical component 23 may be configured to obtain and/or determine, for individual business entities, one or more statistical parameters, e.g. variance and/or average, for the set of financial parameters of companies A, B, and C in FIG. 2A.

As additional financial information becomes available, e.g. Q1 of year n+5, statistical component 23 may be configured to re-evaluate a previously-made determination. For example, in some implementations, determinations by statistical component 23 may be based on a predetermined number of the most recent financial parameters. In some implementations, the predetermined number may correspond to 4, 5, 6, 7, 8, 9, and/or 10 years of financial information. In some implementations, determinations by statistical component 23 may be based on a moving average of one or more financial parameters.

Referring to FIG. 1, in some implementations, statistical component 23 may be configured to obtain and/or determine statistical parameters related to financial parameters of two or more business entities and/or stocks thereof. For example, statistical component 23 may be configured to determine a covariance between two sets of particular financial performance parameters, each set being specific to a different business entity or stock. In some implementations, to determine a covariance, the two sets may need to span the same range of dates. For example, assuming that the variance of the ROE for company A (V_{ROE-A}) spans the same range of dates as the variance of the ROE for company B (V_{ROE-B}), statistical component 23 may be configured to determine a covariance between the ROE of company A and company B, which may be referred to as CV_{ROE-AB}, or CV_{AB} for short. Likewise, the covariance between the ROE (or another financial parameter) of company X and company Y may be referred to as CV_{XY}.

Eligibility component 25 may be configured to select and/or discard individual business entities from the set of business entities based on one or more eligibility criteria. Eligibility component 25 may be configured to select and/or discard individual stocks from the set of stocks based on one or more eligibility criteria. In some implementations, selecting and/or discarding a business entity or stock may imply selecting and/or discarding the corresponding stock or business entity, and vice versa.

In some implementations, one or more of the eligibility criteria may be based on whether a business entity is considered “United States large cap”, or “U.S. large cap”. In some implementations, one or more eligibility criteria may be based on one or more of the place of incorporation of a business entity, valuation information of a business entity, size and/or financial performance of a business entity, the number of employees, location of headquarters, location where stocks are traded, location of assets, location of revenues, location of the most liquid exchange (e.g. as defined by two-year average daily dollar trading volume), home country indicators, non-financial parameters of a business entity and/or other business information. In some implementations, one or more eligibility criteria may be similar or the same as the known, published, and stable eligibility criteria used to construct, e.g., a Russell U.S. Equity Index, including but not limited to the Russell 3000E™ Index, the Russell 1000® Index, and/or other equity indexes. In some implementations, home country indicators (or HCIs) may include the country of incorporation, the country of headquarters, and the country of the most liquid exchange as defined by two-year average daily dollar trading volume from all exchanges within a country. In some implementations, one or more eligibility criteria may be based on whether a business entity has a particular relation with a so-called Benefit Driven Incorporation (BDI)-country, which is a list of countries. In some implementations, the list of BDI countries includes Anguilla, Antigua and Barbuda, Aruba, Bahamas, Barbados, Belize, Bermuda, Bonaire, British Virgin Islands, Cayman Islands, Channel Islands, Cook Islands, Curacao, Faroe Islands, Gibraltar, Isle of Man, Liberia, Marshall Islands, Panama, Saba, Sint Eustatius, Sint Maarten, and Turks and Caicos Islands. In some implementations, a determination of whether a business entity has a country assignment of “United States” may involve a sequence of at least the following four steps (in addition to the criteria of being traded in the U.S.): 1) Is the business entity incorporated in, traded in, and headquartered in one unique country? If so, this business entity is classified in that country. Else, the determination proceeds to step 2: Are the business entity's reported assets primarily located in one of the HCIs? If so, this business entity is classified in the country of primary assets. Else, the determination proceeds to step 3: Are the business entity's reported revenues primarily derived from one of the HCIs? If so, this business entity is classified in the country of primary revenue. Else, the determination proceeds to step 4: Is the business entity headquartered in a non-BDI country? If so, this business entity is classified in the country of the headquarters. Else, this business entity is classified in the country of primary exchange. In some implementations, one or more eligibility criteria may be based on whether the business entity is classified in the U.S. using these four steps.

In some implementations, one or more of the eligibility criteria may be based on one or more statistical parameters that are specific to individual business entities. For example, business entities having below-average ROE (or below some threshold) may be discarded. In some implementations, eligibility component 25 may be configured such that higher ROE may be preferred for inclusion in a stock index. In some implementations, business entities having above average variance of ROE (or above some threshold) may be discarded. In some implementations, eligibility component 25 may be configured such that lower variance of ROE may be preferred for inclusion in a stock index.

In some implementations, one or more of the eligibility criteria may be based on one or more statistical parameters that are not specific to individual business entities, but rather related to the relation and/or interaction between different business entities and/or stocks. For example, one or more eligibility criteria may be based on covariance between financial parameters of two business entities.

Portfolio component 28 may be configured to determine one or more index parameters. An index parameter may reflect a financial parameter for a set of business entities and/or stocks. An index parameter may be scalar or multi-dimensional (e.g. a vector). For example, an index parameter may reflect ROE for the subset of stocks (and/or their corresponding business entities) selected by eligibility component 25. In some implementations, an index parameter may reflect a statistical parameter based on a financial parameter for a set of business entities and/or stocks. For example, an index parameter may reflect the variance of ROE for the subset of stocks (and/or their corresponding business entities) selected by eligibility component 25.

Index component 24 may be configured to determine a stock index of a set of stocks. For example, index component 24 may be configured to determine a stock index of the subset of stocks, e.g. as selected by eligibility component 25. Individual stocks included in the stock index may be associated with a particular weight or weight factor that reflect how much the stock index depends on a particular stock.

In some implementations, index component 24 may be configured to determine individual weights for individual stocks in the subset of stocks that are included in the stock index. In some implementations, individual weights may be determined by minimizing, reducing, maximizing, and/or increasing one or more index parameters. For example, individual weights may be determined by reducing and/or minimizing the variance of an index parameter that reflects ROE for the subset of stocks included in the stock index. In some implementations, determination of individual weights may be based on a variance-covariance matrix, as described in relation to matrix component 26.

In some implementations, determination of weights may be subject to one or more constraints, including but not limited to a minimum weight (e.g. zero), a maximum weight (e.g. a predetermined fraction of the stock index), and/or other constraints.

Matrix component 26 may be configured to generate a covariance matrix and/or variance-covariance matrix for the subset of stocks based on statistical parameters, e.g. the statistical parameters obtained by statistical component 23. For example, for a covariance matrix of company A, B, and C, the entries in the covariance matrix may be (from left to right, from top to bottom) V_{A}, CV_{AB}, CV_{AC}; CV_{BA}, V_{B}, CV_{BC}; CV_{CA}, CV_{CB}, V_{C}. In some implementations, the covariance matrix may be referred to as a variance-covariance matrix. By way of illustration, FIG. 2B illustrates a variance-covariance matrix for companies A, B, C, and/or other companies, including the entries described above. In some implementations, index component 24 may be configured to determine weights for the stocks included in the stock index by minimizing (and/or approximating a minimum) the variance of the ROE of the stock index based on the variance-covariance matrix. In some implementations, determination of weights may include performing one or more operations on the variance-covariance matrix, including but not limited to optimization operations commonly used for minimum-variance strategies (e.g. strategies for minimizing the variance of stock returns). For example, optimization operations may include operations to shrink the matrix.

Rebalance component 27 may be configured to rebalance the stock index through adjustments of the selected subset of stocks and/or adjustments of corresponding weights. Adjustments of the individual weights may be determined by minimizing the variance of the index parameter, e.g. in light of new financial parameters for the set of business entities that were not available or used when the stock index was created, determined, or previously rebalanced. In some implementations, selection and/or discarding of business entities and/or corresponding stocks may form part of rebalancing a stock index.

Referring to FIG. 1, one or more processors 20 may be configured to provide information processing capabilities in system 10 and/or server 11. As such, processor 20 may include one or more of a digital processor, an analog processor, a digital circuit designed to process information, an analog circuit designed to process information, a state machine, and/or other mechanisms for electronically processing information. Although processor 20 may be shown in FIG. 1 as a single entity, this is for illustrative purposes only. In some embodiments, processor 20 may include a plurality of processing units. These processing units may be physically located within the same device, or processor 20 may represent processing functionality of a plurality of devices operating in coordination (e.g., “in the cloud”, and/or other virtualized processing solutions).

It should be appreciated that although components 22-28, are illustrated in FIG. 1 as being co-located within a single processing unit, in implementations in which processor 20 includes multiple processing units, one or more of components 22-28 may be located remotely from the other components. The description of the functionality provided by the different components 22-28 described herein is for illustrative purposes, and is not intended to be limiting, as any of components 22-28 may provide more or less functionality than is described. For example, one or more of components 22-28 may be eliminated, and some or all of its functionality may be provided by other ones of components 22-28. As another example, processor 20 may be configured to execute one or more additional components that may perform some or all of the functionality attributed herein to one of components 22-28.

Physical storage 60 of system 10 in FIG. 1 may comprise electronic storage media that stores information. In some embodiments, physical storage 60 may store representations of computer program components, including instructions that implement the computer program components. The electronic storage media of physical storage 60 may include one or both of system storage that is provided integrally (i.e., substantially non-removable) with server 11 and/or removable storage that is removably connectable to server 11 via, for example, a port (e.g., a USB port, a FireWire™ port, etc.) or a drive (e.g., a disk drive, etc.). Physical storage 60 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), network-attached storage (NAS), and/or other electronically readable storage media. Physical storage 60 may include virtual storage resources, such as storage resources provided via a cloud and/or a virtual private network. Physical storage 60 may store software algorithms, information determined by processor 20, information received via client computing platforms 14, and/or other information that enable server 11 and system 10 to function properly. Physical storage 60 may be separate components within system 10, or physical storage 60 may be provided integrally with one or more other components of system 10 (e.g., processor 20).

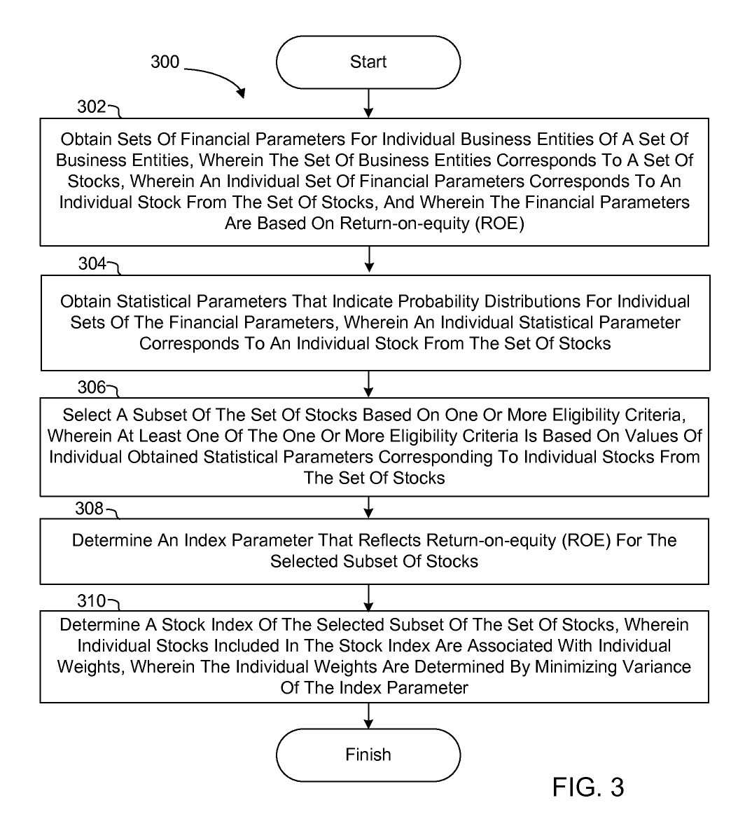

FIG. 3 illustrates method 300 for providing a stock index. The operations of method 300 presented herein are intended to be illustrative. In some embodiments, method 300 may be accomplished with one or more additional operations not described, and/or without one or more of the operations discussed. Additionally, the order in which the operations of method 300 are illustrated in FIG. 3, and described herein, are not intended to be limiting.

Regarding FIG. 3 and method 300, at an operation 302, sets of financial parameters are obtained for individual business entities of a set of business entities. The set of business entities corresponds to a set of stocks. An individual set of financial parameters corresponds to an individual stock from the set of stocks. The financial parameters are based on return-on-equity (ROE). In some embodiments, operation 302 is performed by a historical component the same as or similar to historical component 22 (shown in FIG. 1 and described herein).

At an operation 304, statistical parameters are obtained that indicate probability distributions for individual sets of the financial parameters. An individual statistical parameter corresponds to an individual stock from the set of stocks. In some embodiments, operation 304 is performed by a statistical component the same as or similar to statistical component 23 (shown in FIG. 1 and described herein).

At an operation 306, a subset of the set of stocks is selected based on one or more eligibility criteria. At least one of the one or more eligibility criteria is based on values of individual obtained statistical parameters corresponding to individual stocks from the set of stocks. In some embodiments, operation 306 is performed by an eligibility component the same as or similar to eligibility component 25 (shown in FIG. 1 and described herein).

At an operation 308, an index parameter is determined that reflects return-on-equity (ROE) for the selected subset of stocks. In some embodiments, operation 308 is performed by a portfolio component the same as or similar to portfolio component 28 (shown in FIG. 1 and described herein).

At an operation 310, a stock index of the selected subset of the set of stocks is determined. Individual stocks included in the stock index are associated with individual weights. The individual weights are determined by minimizing variance of the index parameter. In some embodiments, operation 310 is performed by an index component the same as or similar to index component 24 (shown in FIG. 1 and described herein).

In some embodiments, method 300 may be implemented in one or more processing devices (e.g., a server, a digital processor, an analog processor, a digital circuit designed to process information, an analog circuit designed to process information, and/or other mechanisms for electronically processing information). The one or more processing devices may include one or more devices executing some or all of the operations of method 300 in response to instructions stored electronically on an electronic and/or physical storage medium. The one or more processing devices may include one or more devices configured through hardware, firmware, and/or software to be specifically designed for execution of one or more of the operations of method 300.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation (or claim) can be combined with one or more features of any other implementation (or claim).

1. A system configured to provide a stock index including stocks and weights associated with the stocks, the system comprising:
physical electronic storage comprising storage media that stores information; and
one or more physical processors configured to execute computer program components, wherein the computer program components are configured by instructions stored electronically on the physical electronic storage to:
obtain sets of financial parameters for individual business entities of a set of business entities, wherein the set of business entities corresponds to a set of stocks, wherein an individual set of financial parameters corresponds to an individual stock from the set of stocks, and wherein the financial parameters are based on return-on-equity (ROE);
obtain statistical parameters that indicate probability distributions for individual sets of the financial parameters, wherein an individual statistical parameter corresponds to an individual stock from the set of stocks; and
select a subset of the set of stocks based on one or more eligibility criteria, wherein at least one of the one or more eligibility criteria is based on values of individual obtained statistical parameters corresponding to individual stocks from the set of stocks;
determine an index parameter that reflects return-on-equity (ROE) for the selected subset of stocks; and
determine a stock index of the selected subset of the set of stocks, wherein individual stocks included in the stock index are associated with individual weights, wherein the individual weights are determined by minimizing variance of the index parameter.

2. The system of claim 1, wherein the computer program components are further configured such that the one or more eligibility criteria include a first eligibility criterion and a second eligibility criterion, wherein the first eligibility criterion is based on a first threshold for an average value of an individual set of financial parameters, and wherein the second eligibility criteria is based on a second threshold for an average value of an individual statistical parameter.

3. The system of claim 1, wherein the computer program components are further configured to:
obtain historical balance sheet information for the set of business entities,
wherein the financial parameters are based on the historical balance sheet information.

4. The system of claim 1, wherein the computer program components are further configured to:
obtain historical stock price information for the set of stocks,
wherein the financial parameters are based on the historical stock price information.

5. The system of claim 1, wherein the computer program components are further configured to:
discard individual business entities from the set of business entities based on at least one of the one or more eligibility criteria.

6. The system of claim 1, wherein the computer program components are further configured such that at least one of the one or more eligibility criteria is based on valuation information of the individual business entities.

7. The system of claim 1, wherein the computer program components are further configured such that at least one of the one or more eligibility criteria is based on place of incorporation of the individual business entities.

8. The system of claim 1, wherein the computer program components are further configured such that individual financial parameters of individual sets are associated with a date or a date range.

9. The system of claim 1, wherein the computer program components are further configured such that individual sets of financial parameters for individual business entities span a historical period.

10. The system of claim 1, wherein the computer program components are further configured such that the sets of financial parameters for individual business entities span at least a period of 5 years.

11. The system of claim 1, wherein the computer program components are further configured such that the sets of financial parameters for individual business entities include at least 1 data point per quarter.

12. The system of claim 1, wherein the computer program components are further configured such that the sets of financial parameters for individual business entities include at least about 20 data points per set.

13. The system of claim 1, wherein the computer program components are further configured such that the return-on-equity (ROE) for individual business entities is based on one or both of historical stock price information and/or historical balance sheet information.

14. The system of claim 13, wherein the computer program components are further configured such that the historical balance sheet information for individual business entities includes earnings after taxes and at least one of book value and average book value.

15. The system of claim 13, wherein the computer program components are further configured such that the historical balance sheet information for individual business entities includes net income and shareholders' equity.

16. The system of claim 13, wherein the computer program components are further configured such that the historical balance sheet information for individual business entities includes net margin, asset turnover, and financial leverage.

17. The system of claim 1, wherein the computer program components are further configured such that an individual statistical parameter that indicates a probability distribution for an individual set of the financial parameters is based on variance of the financial parameters in the individual set.

18. The system of claim 1, wherein the computer program components are further configured such that at least one of the one or more eligibility criteria is based on an aggregate of the financial parameters in individual sets.

19. The system of claim 1, wherein the computer program components are further configured such that at least one of the one or more eligibility criteria is based on an aggregate of the statistical parameters that indicate probability distributions for individual sets of the financial parameters.

20. The system of claim 1, wherein the stock index is determined by the computer program components being further configured to:
generate a covariance matrix for the subset of stocks based on the obtained statistical parameters.

21. The system of claim 20, wherein the computer program components are further configured such that the individual weights are determined within one or more constraints, wherein the one or more constraints include a first requirement that an individual weight is greater than zero.

22. The system of claim 21, wherein the computer program components are further configured such that the one or more constraints include a second requirement that an individual weight is smaller than a predefined fraction of the stock index.

23. The system of claim 1, wherein the computer program components are further configured to:
obtain additional financial parameters for individual business entities of a set of business entities, wherein the additional financial parameters are more recent than the obtained financial parameters;
obtain additional statistical parameters that indicate probability distributions for individual sets including one or more of the financial parameters and the additional financial parameters; and
rebalance the stock index through adjustments of the individual weights, wherein adjustments of the individual weights are determined by minimizing the variance of the index parameter.

24. The system of claim 23, wherein the computer program components are further configured such that individual sets include a predetermined number of the most recent financial parameters selected from a combination of the financial parameters and the additional financial parameters.

25. A computer-implemented method to provide a stock index including stocks and weights associated with the stocks, the method being implemented in a computer system that includes one or more physical processors, the method comprising:
obtaining sets of financial parameters for individual business entities of a set of business entities, wherein the set of business entities corresponds to a set of stocks, wherein an individual set of financial parameters corresponds to an individual stock from the set of stocks, and wherein the financial parameters are based on return-on-equity (ROE);
obtaining statistical parameters that indicate probability distributions for individual sets of the financial parameters, wherein an individual statistical parameter corresponds to an individual stock from the set of stocks; and
selecting, by the one or more physical processors, a subset of the set of stocks based on one or more eligibility criteria, wherein at least one of the one or more eligibility criteria is based on values of individual obtained statistical parameters corresponding to individual stocks from the set of stocks;
determining, by the one or more physical processors, an index parameter that reflects return-on-equity (ROE) for the selected subset of stocks; and
determining, by the one or more physical processors, a stock index of the selected subset of the set of stocks, wherein individual stocks included in the stock index are associated with individual weights, wherein the individual weights are determined by minimizing variance of the index parameter.

26. The method of claim 25, wherein the one or more eligibility criteria include a first eligibility criterion and a second eligibility criterion, wherein the first eligibility criterion is based on a first threshold for an average value of an individual set of financial parameters, and wherein the second eligibility criteria is based on a second threshold for an average value of an individual statistical parameter.

27. The method of claim 25, further comprising:
discarding individual business entities from the set of business entities included in the subset, wherein discarding is based on at least one of the one or more eligibility criteria.

28. The method of claim 25, wherein at least one of the one or more eligibility criteria is based on valuation information of the individual business entities.

29. The method of claim 25, wherein at least one of the one or more eligibility criteria is based on place of incorporation of the individual business entities.

30. The method of claim 25, wherein at least one of the one or more eligibility criteria based on an aggregate of the financial parameters in individual sets.
